(19) United States
(12) Patent Application Publication
(10) Pub. No.: US 2018/0189474 A1
(43) Pub. Date: Jul. 5, 2018

(54) Method and Electronic Device for Unlocking Electronic Device

(71) Applicant: BAIDU ONLINE NETWORK TECHNOLOGY (BEIJING) CO., LTD., Beijing (CN)

(72) Inventors: Zhongqin Wu, Beijing (CN); Hui Qiao, Beijing (CN); Yingchao Li, Beijing (CN); Qian Ying, Beijing (CN); Chen Zhao, Beijing (CN)

(73) Assignee: BAIDU ONLINE NETWORK TECHNOLOGY (BEIJING) CO., LTD., Beijing (CN)

(21) Appl. No.: 15/619,239

(22) Filed: Jun. 9, 2017

(30) Foreign Application Priority Data
Dec. 30, 2016 (CN) 201611261977.4

(51) Int. Cl. G06F 21/36; G06T 11/60; A63F 13/2145; A63F 13/426

(52) U.S. Cl. CPC G06F 21/36; G06T 11/60; G06F 3/0346; A63F 13/426; A63F 13/2145

(57) ABSTRACT

The present application discloses a method and an electronic device for unlocking an electronic device. The method comprises: displaying an unlocking interface on the display of the electronic device when the electronic device is in a locked state, wherein the unlocking interface comprises a real world scene acquired by the camera of the electronic device and one or more virtual objects superimposed on the real world scene; detecting the interaction with the unlocking interface; and switching the electronic device to an unlocked state if the interaction satisfies predefined rules. The schemes according to the various embodiments of the present disclosure provide an unlocking interface and an unlocking electronic device that are more effective, more convenient to use, and more user-friendly.

### CROSS-REFERENCE TO RELATED APPLICATION

This application claims the priority of Chinese Patent Application No. 201611261977.4, entitled “Method and Electronic Device for Unlocking Electronic Device,” filed on Dec. 30, 2016, the content of which is incorporated herein by reference in its entirety.

### TECHNICAL FIELD

The present disclosure relates generally to electronic devices, in particular to a method and an electronic device for unlocking electronic devices.

### BACKGROUND

Many electronic devices incorporate a touch screen for displaying graphics and text, and provide an interface enabling the user to interact with the device. The touch screen detects and responds to the touch on the touch screen. The device can display on the touch screen one or more buttons, menus, and other user interfaces. The user may touch the touch screen portion corresponding to the user interface object with which she desires to interact, so as to interact with the device.

On mobile phones and other electronic devices, it becomes more and more popular to incorporate a touch screen as a display and user input component. A problem with incorporating a touch screen on an electronic device is that some function may be activated or deactivated inadvertently by touching the touch screen accidentally. Therefore, the electronic device may be locked once a predefined condition, such as at the end of a predefined idle period, is satisfied.

Any of a number of means can be used to switch the electronic device into a working state, for example by detecting the gesture or the touch on the touch screen, and detecting the fingerprint or the password entered. Nevertheless, these unlocking means suffer from some drawbacks. Gesture or contact unlocking does not offer good privacy, likely to be taken advantage of by others; a password might be forgotten; and detecting a fingerprint may involve extra components. All this harms the ease of use of electronic devices.

### SUMMARY

Given the aforesaid defects or drawbacks of the prior art, it is desirable to provide a more effective scheme for unlocking an electronic device.

In one aspect, the embodiments of the present disclosure provide a method for unlocking an electronic device, comprising: displaying an unlocking interface on the display of the electronic device when the electronic device is in a locked state, wherein the unlocking interface comprises a real world scene acquired by a camera of the electronic device and one or more virtual objects superimposed on the real world scene; detecting an interaction with the unlocking interface; and switching the electronic device to an unlocked state if the interaction satisfies a predefined rule.

In a further aspect, the embodiments of the present disclosure provide an electronic device, comprising: a display; a camera; a processor; and a memory coupled to the processor and storing instructions, the instructions when executed by the processor causing the processor to execute operations of unlocking the electronic device, the operations comprising: displaying an unlocking interface on the display when the electronic device is in a locked state, wherein the unlocking interface comprises a real world scene acquired by the camera of the electronic device and one or more virtual objects superimposed on the real world scene; detecting an interaction with the unlocking interface; and switching the electronic device to an unlocked state if the interaction satisfies a predefined rule.

In a still further aspect, the embodiments of the present disclosure further provide a non-transitory computer-readable medium storing instructions, the instructions when executed by the processor causing the processor to execute the above-described unlocking operation.

The schemes of unlocking an electronic device provided by the embodiments of the present disclosure make use of augmented reality technology, superimpose virtual objects on a real world scene displayed on the display of the electronic device, and unlock the electronic device in response to the operation on the virtual objects. According to the schemes in the various embodiments of the present disclosure, there are provided an unlocking interface and an unlocking electronic device that are more effective, more convenient to use, and more user-friendly.

### BRIEF DESCRIPTION OF THE DRAWINGS

Other features, objectives, and advantages of the present application will become more apparent upon consideration of the following detailed description of the non-restrictive embodiments with reference to the following drawings:

FIG. 1 shows an exemplary block diagram of the electronic device that is able to implement one or more aspects of the present disclosure;

FIG. 2 shows an exemplary flow chart of a method for unlocking an electronic device according to an embodiment of the present disclosure;

FIG. 3 shows an exemplary unlocking interface; and

FIG. 4 shows an exemplary flow chart of a method for unlocking an electronic device according to an embodiment of the present disclosure.

### DETAILED DESCRIPTION OF EMBODIMENTS

Detailed description of the present disclosure is given below with reference to the accompanying drawings and embodiments. It should be understood that the embodiments described herein are provided for the sole purpose of explaining the disclosure, rather than limiting the disclosure. It should also be noted that, for the convenience of description, the accompanying drawings only show the portions related to the invention.

It should be noted that the embodiments in the present application and the features in the embodiments may be used in combination where no conflict exists. The following gives a detailed description of the present application with reference to the accompanying drawings and the embodiments.

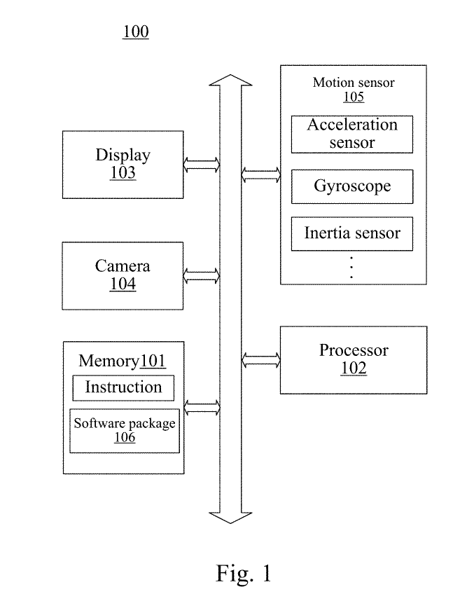

FIG. 1 shows the block diagram of an exemplary electronic device that is able to implement one or more aspects of the present disclosure. With reference to FIG. 1, the exemplary electronic device 100 may include: a memory 101, a processor 102, a display 103, a camera 104, and a motion sensor assembly 105. The electronic device 100 can be any portable electronic device, including but not limited to a smart phone, a tablet device, a laptop computer, a personal digital assistant, or any combination thereof. It should be understood that the electronic device 100 is only an example of the devices that are able to implement the present disclosure and the electronic device 100 may have more or fewer parts than or have a different configuration from what are shown.

The memory 101 can be a volatile memory such as a random access memory (RAM), a static RAM (SRAM), and a dynamic RAM (DRAM), or a non-volatile memory such as a read only memory (ROM), a flash memory, and a magnetic disk, or any combination of the two kinds of memory. The memory 204 can be used to store program instructions executable by the processor 203. These program instructions when executed by the processor 203 are able to implement all or a portion of the functions described in the present disclosure.

The display 103 can provide the user with visual output. Such visual output may include text, graphics, videos, or a combination thereof. In certain embodiments, the display 103 is a touch-sensitive display, acting as both an input interface and an output interface between the device and the user. The touch-sensitive display has a sensitive surface that can detect the contact of the user and is able to convert the detected contact into an interaction with one or more objects shown on the touch screen. As will be described below, in the embodiments of the present disclosure such an object can be a virtual object generated using augmented reality technology and superimposed on a real world scene and displayed on the electronic device 100 in a locked state.

The processor 102 can be a general processor such as a central processing unit (CPU), a microcontroller unit (MCU), and a digital signal processor (DSP), and is configured such that the program instructions stored in the memory 204 are executed to implement all or a portion of the functions described herein. Additionally or alternatively, the processor 203 may further include programmable hardware elements, such as an application-specific integrated circuit (ASIC), a field programmable gate array (FPGA), and the like.

The electronic device 100 further includes an image component, for example, one or more cameras 104, for acquiring real world scenes, and a motion sensor 105 such as an acceleration sensor, a gyroscope, an inertia sensor, and a gravity sensor. In some configurations, the electronic device 100 has a rear camera provided on the back face and a front camera provided on the front face. The motion sensor 105 can be used to acquire the motion data such as attitude (say, orientation) and movement (say, shaking, and rotation) of the electronic device 100. Such motion data can be converted into an interaction with the visual objects shown on the display 103.

The electronic device 100 can still include software packages 106. Software packages 106 include, for example, an operating system, and one or more Apps executable on the electronic device. Exemplary Apps include browsers, e-mail, instant messaging, album, audio, and video Apps. These software packages can be stored in memory 101. As will be described below, the unlocking of the electronic device 100 can be done with respect to the electronic device 100 itself or to on one or more of these Apps.

It is to be understood that in addition to the above-described components the electronic device 100 may include other publicly known components. For example, telecommunication components such as an antenna, and a transceiver, and input/output components such as a speaker, a microphone, a button, and a touchpad. To avoid blurring unnecessarily the present disclosure, such publicly known structures are not shown in FIG. 1.

Generally, the electronic device 100 has a locked state and an unlocked state. In the locked state, the electronic device 100 does not respond to most of the user's operations, for example, the navigation through the user interfaces. The electronic device 100 may, for example, enter such a locked state when no user input is received within a predetermined time. Alternatively, the electronic device 100 may enter the locked state in response to the user's manual locking of the display, so as to avoid unintentional activation or deactivation of certain functions or the use of the device by others. In the locked state, the electronic device 100 can respond to appropriate unlocking operations, so as to switch from the locked state to the unlocked state. Such a process is herein termed “unlocking”. In the unlocked state, the device 100 can operate normally, and detect and respond to the interaction with a user interface, for example, providing an input object for receiving input data, opening or closing an App, navigating through the interface of different Apps or through different interfaces of a same App, and responding to the user selecting to play audio or video.

As described above, the device can be unlocked through detecting one or more of a sliding contact, a gesture, a fingerprint, and a password. However, these unlocking modes have drawbacks and reduce the ease of use of electronic devices.

The various embodiments of the present disclosure have a purpose of providing an unlocking electronic device that are more effective, more convenient to use, and more user-friendly.

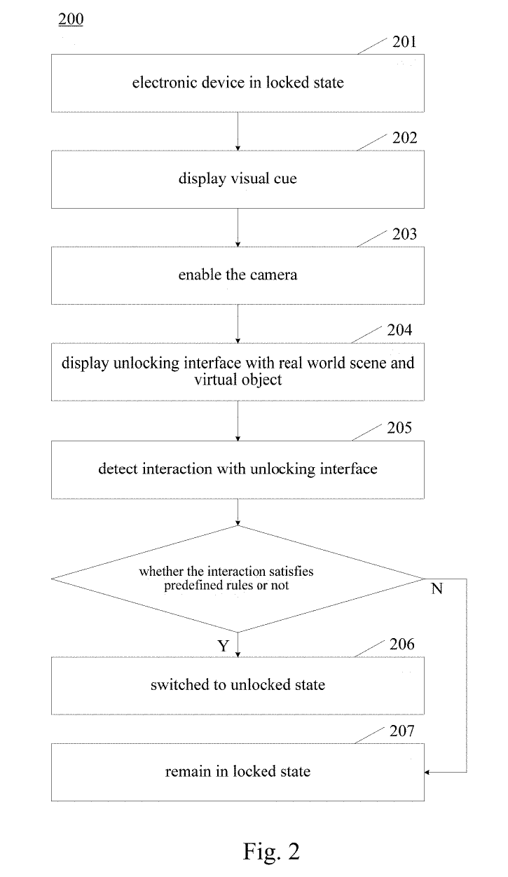

Now with reference to FIG. 2, there is shown an exemplary flow chart of a method for unlocking an electronic equipment according to the embodiments of the present disclosure. The method 200 can be implemented on the electronic device 100 described with reference to FIG. 1. It should be understood that while the method 200 described below includes a number of operations appearing in a certain sequence, the method may include more or fewer operations and such operations may be executed in sequence or in parallel.

As shown in FIG. 2, in block 201 the electronic device 100 is set in the locked state.

The electronic device 100 enters the locked state when any of the locking conditions is satisfied. As described above, exemplary locking conditions may include the receipt of a screen-locking operation from the user (for example, pressing the screen-locking button), and a predefined inactivity time. Generally, when the electronic device 100 is set in the locked state, the display of the electronic device (e.g., a touch-sensitive display) is switched off.

In block 202, a visual cue is displayed on the display of the electronic device 100.

In some embodiments, the display of the electronic device 100 is turned on in response to a particular event. Events may include the receipt of an incoming call or an SMS, an App notice, an alarm, or other events demanding the user's attention. In some other embodiments, the display is turned on in response to an operation from the user for waking up the display (e.g., a touch-sensitive display). Such operations include, for example, clicking for one time or for more times continually on a touch sensitive display, shaking or overturning the electronic device, pressing the power key or the Home key, and sliding on the touch-sensitive display.

After the display of the electronic device 100 is turned on, one or more visual cues may be displayed on the touch-sensitive display. The visual cues can provide the user with a reminder or a notice about the subsequent unlocking operation. Such visual cues can be text, graphics, or any combination thereof.

In one embodiment, the visual cue can be images. In another embodiment, the visual cue may be a screen saver interface with date, time, remaining power, and other information that the user may be interested in. In other embodiments, the visual cue is a slider with a predetermined path.

In block 203, the electronic device 100 enables the camera in response to the operation on the visual cue.

Generally, the camera of the electronic device is disabled when the electronic device is in the locked state (e.g., when the display is turned off or during an unlocking process), which is good for power saving. As will be described below, in the embodiments of the present disclosure the electronic device is unlocked using virtual objects generated using the display-based augmented reality (AR) technology. In such an AR application, a real world object is imaged and displayed on the display along with information (such as an image, an animation, or text) generated by the electronic device. For portable electronic devices such as mobile phones and tablets, real-world objects can be acquired by a camera on the electronic device.

In an embodiment, a real world scene containing a real world object will be provided by the camera on the electronic device 100. To this end, the electronic device 100 enables the camera after receiving an appropriate operation in respect of the visual presentation. Exemplary operations include, for example, moving an image to a predetermined location or touching the touch-sensitive display surface nonstop along a predetermined path.

In block 204, an unlocking interface is shown on the display of the electronic device 100.

The unlocking interface includes a real world scene acquired by the camera of the electronic device 100 and a virtual object. Unlike a real world scene, a virtual object is generated by the electronic device. By use augmented reality technology, such virtual objects can be superimposed on a real world scene as a supplement or an augmentation to the real world scene.

In the embodiments of the present disclosure, real world scenes are environment images acquired by the camera of the electronic device. Real scenes can include a variety of real world objects, such as buildings, vehicles, skies, plants, and household items.

Virtual objects can include dynamic or static objects. In some embodiments, the virtual objects may include animated images, such as a number of balloons floating in the sky, automobiles traveling on the ground, etc.

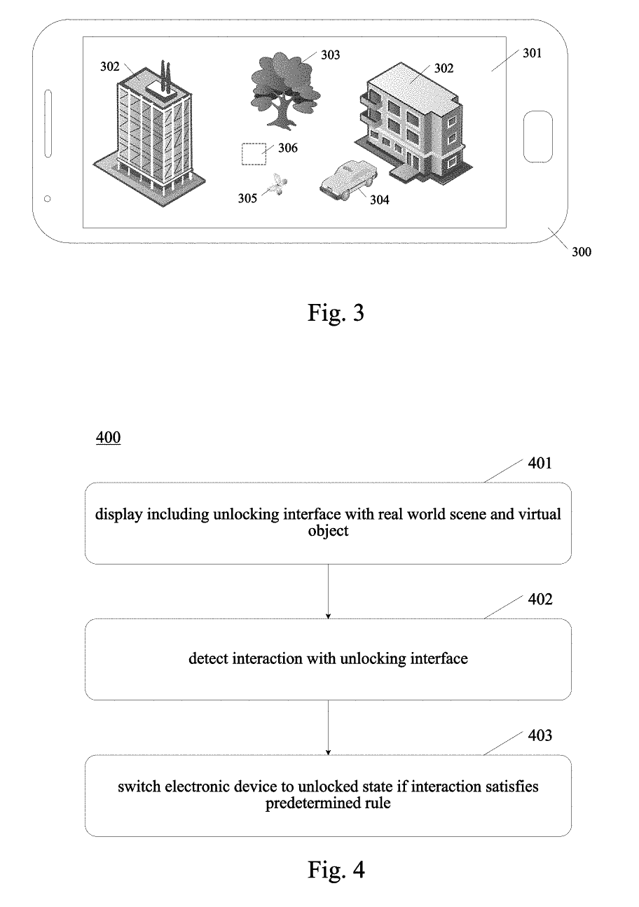

Now with reference to FIG. 3, it illustrates an exemplary unlocking interface presented on the touch-sensitive display of an electronic device. In one exemplary scene, the electronic device is a mobile phone 300. The user of the mobile phone 300 desires to unlock it so as to enter the navigation interface. The camera of the mobile phone 300 is enabled after the user has performed an appropriate operation on the visual presentation. Then, the user may choose to aim the camera of the mobile phone 300 at the environment outside the window to acquire an environment image. The environment image is displayed in real time on the touch-sensitive display 301 of the mobile phone 300. As shown in FIG. 3, exemplary environment images may include a number of buildings 302, trees 303, and vehicles 304, which are herein referred to as “real world objects.”

One or more virtual objects may be superimposed on the environment image (i.e., the real world scene). In the example of FIG. 3, the virtual objects include a butterfly 305 floating in the air, and a net 306 for catching the butterfly. The butterfly 305 can be shown to fly in the air along a predetermined path.

Again with reference to FIG. 2, in block 205 the interaction with the unlocking interface is detected.

After the unlocking interface is provided, the user can interact with the unlocking interface to attempt to unlock the electronic device.

Again with reference to the example in FIG. 3, the user may perform an unlocking action to cause the net 306 to move on the unlocking interface. In the example, the unlocking action includes moving (e.g., tilting or rotating) the electronic device 300. Such a movement can be detected by a motion sensor such as a gyroscope, an acceleration sensor, and be converted to an operation on the net 306. For example, when the electronic device is tilted to the left, the net 306 moves leftward on the unlocking interface; when the electronic device is tilted forward, the net 306 moves upward on the unlocking interface.

In some examples, an unlocking action may also include non-contact gesture that the user performs before the display. Such gestures can be captured, for example, by the front camera of the electronic device 100. As an example, the net 306 may move on the unlocking interface in response to the gestures.

Additionally or alternatively, an unlocking action may also include contact with a touch-sensitive display, or pressing a key on the electronic device, such as a volume or power button. Similarly, the operation on the keys can also be converted into interaction with a virtual object (e.g., the net 306).

In block 206, the electronic device 100 is switched to the unlocked state if the interaction satisfies predetermined rules.

Further with reference to the example in FIG. 3, an exemplary rule is to use the net 306 to catch the butterfly 305. The electronic device 100 may switch to the unlocked state if the user's unlocking action is such that the net 306 meets the flying butterfly 305.

It should be understood that the example in FIG. 3 is not restrictive. A virtual object can also be any other desirable type or image, and the rules of interaction can be defined differently.

As described above, there is a consideration of security and ease of use for the unlocking of an electronic device. When in a private environment, the simple unlocking mode shown in FIG. 3 may be used. However, such an unlocking mode may have some security flaws, making the electronic device prone to abuse by others.

More complex rules can be provided in order to improve the security of the unlocking mode. In some embodiments, a number of butterflies can be included in 305 in FIG. 3. The electronic device 100 switches to the unlocked state only when all the butterflies 305 are caught in a particular sequence. Such a rule is not likely to be known by others. In addition, the rule can also be customized by the user, which improves the security further.

Thus, in an embodiment of the present disclosure, the unlocking interface can be implemented as a game based on augmented reality technology. It is safer than the unlocking mode of image sliding. Compared with passwords, the rules of a game are not so easy to forget.

In such a game, the state of one or more of the virtual objects can be changed dynamically in response to the interaction with the unlocking interface so as to make the unlocking mode more user-friendly. In some embodiments, one or more virtual balloons may be used instead of the butterfly 305 in FIG. 3, and when a balloon is selected, it is shown to be punctured. The electronic device 100 switches to the unlocked state when a number of balloons have been punctured in the sequence of color.

In some other embodiments, the unlocking interface may include some falling virtual props, such as bubbles, coins, and any other desired objects, to be superimposed on a real world scene. The electronic device 100 switches to the unlocked state when the user catches these objects by shaking the mobile phone.

In some other embodiments, virtual objects superimposed on a real world scene may be used as targets in a shooting game or in other games.

Additionally or alternatively, the interaction with the unlocking interface may also involve real world objects therein. Additionally, it is also possible to generate associated virtual objects based on real world objects. As an example and with reference to the unlocking process in FIG. 3, when the camera of the electronic device 100 is aimed at the tree 303, virtual objects related to the tree 303 such as squirrels and monkeys can be generated. The user may attempt to unlock the electronic device 300 by shooting these objects.

In block 207, the electronic device 100 remains in the locked state if the interaction does not satisfy predetermined rules.

The unlocking schemes are described above with respect to the locked state of the electronic device 100. Nevertheless, in such a locked state the electronic device 100 ignores most of the user's operations other than the unlocking actions. It should be understood that the unlocking schemes of the present disclosure are equally applicable to various Apps such as instant messaging and albums. When an App is in a locked state, the user has limited authority with respect to it, for example, the user is not allowed to view or implement the message log, or browse the album. However, the user's operation on the system or other Apps is not restricted.

The schemes of unlocking an electronic device provided by the embodiments of the present disclosure make use of augmented reality technology, superimpose virtual objects on a real world scene displayed on the display of the electronic device, and unlock the electronic device in response to the operation on the virtual objects. According to the schemes in the various embodiments of the present disclosure, there are provided an unlocking interface and an unlocking electronic device that are more effective, more convenient to use, and more user-friendly.

Now with reference to FIG. 4, there is shown a flow chart of an exemplary method for unlocking an electronic device. The method 400 comprises the following steps:

In block 401, an unlocking interface is shown on the display of the electronic device when the electronic device is in the locked state.

The unlocking interface includes a real world scene acquired by the camera of the electronic device and one or more virtual objects superimposed on the real world scene.

In block 402, the interaction with the unlocking interface is detected.

In block 403, the electronic device is switched to the unlocked state if the interaction satisfies predetermined rules.

The flow charts and block diagrams in the accompanying drawings illustrate the possible architectures, functions, and operations for the implementation of the systems, methods, and computer program products according to various embodiments of the present disclosure. In this regard, each of the blocks in the flow charts or block diagrams may represent a module, a program segment, or a portion of the code, said module, program segment, or portion of the code comprising one or more executable instructions for implementing specified logic functions. It should also be noted that in some alternative implementations the functions marked in block may also occur in a different sequence than that shown in the accompanying drawings.

For example, any two blocks presented in succession may be executed substantially in parallel, and they may sometimes be executed in the reverse sequence, depending on the function involved. It should also be noted that each block in the block diagrams and/or flow charts, as well as a combination of blocks in the block diagrams and/or flow charts, can be implemented using a dedicated hardware-based system that performs specified functions or operations, or can be implemented using a combination of dedicated hardware and computer instructions.

The units or modules involved in the embodiments described in the present application may be implemented by means of software or hardware. The described units or modules may also be provided in a processor, for example, the description may go like this: a processor comprising selection units and display units. Wherein, the names of these units or modules do not in some cases constitute a limitation to such units or modules themselves.

In another aspect, the present application also provides a computer-readable storage medium, which may be a computer-readable storage medium contained in the apparatus described in the embodiments described above; it may also be a separately provided computer-readable storage medium not contained in the device. The computer-readable storage medium stores one or more programs, said programs being used by one or more processors to perform the electronic device unlocking method described in the present application.

The above description only provides an explanation of the preferred embodiments of the present application and the technical principles used. It should be understood by those skilled in the art that the scope of the invention this application relates to is not limited to the technical schemes constituted by specific combinations of the above-described technical features but should also cover other technical schemes constituted by any combination of the above-described technical features or their equivalent features without departing from the idea of said invention. Technical schemes formed by the above-described features being interchanged with, but not limited to, technical features with similar functions disclosed in the present application are examples.

What is claimed is:

1. A method for unlocking an electronic device, comprising:
displaying an unlocking interface on the display of the electronic device when the electronic device is in a locked state, the unlocking interface comprising a real world scene acquired by a camera of the electronic device and one or more virtual objects superimposed on the real world scene;
detecting an interaction with the unlocking interface; and
switching the electronic device to an unlocked state if the interaction satisfies a predefined rule.

2. The method according to claim 1, further comprising:
displaying a visual part on the display of the electronic device when the electronic device is in the locked state; and
enabling the camera of the electronic device to acquire the real world scene in response to the operation on the visual part.

3. The method according to claim 1, wherein detecting an interaction with the unlocking interface comprises: detecting the operation on one or both of the virtual object and a real world object in the real world scene.

4. The method according to claim 1, further comprising: changing dynamically the state of one or more of the virtual objects in response to the interaction with the unlocking interface.

5. The method according to claim 1, wherein the interaction with the unlocking interface is detected through detecting one or more of:
a movement of the electronic device;
a contact with the display; and
non-contact gestures.

6. An electronic device, comprising:
a display;
a camera;
a processor; and
a memory coupled to the processor and storing instructions, the instructions when executed by the processor causing the processor to execute operations of unlocking the electronic device, the operations comprising:
displaying an unlocking interface on the display when the electronic device is in a locked state, the unlocking interface comprising a real world scene acquired by the camera of the electronic device and one or more virtual objects superimposed on the real world scene;
detecting an interaction with the unlocking interface; and
switching the electronic device to an unlocked state if the interaction satisfies a predefined rule.

7. The electronic device according to claim 6, the operations further comprising:
displaying a visual part on the display of the electronic device when the electronic device is in the locked state; and
enabling the camera of the electronic device to acquire the real world scene in response to the operation on the visual part.

8. The electronic device according to claim 6, wherein detecting an interaction with the unlocking interface comprises: detecting the operation on one or both of the virtual object and a real world object in the real world scene.

9. The electronic device according to claim 6, the operation further comprising: changing dynamically the state of one or more of the virtual objects in response to the interaction with the unlocking interface.

10. The electronic device according to claim 6, wherein the interaction with the unlocking interface is detected through detecting one or more of:
a movement of the electronic device;
a contact with the display; and
non-contact gestures.

11. A non-transitory computer-readable medium storing instructions, the instructions when executed by the processor causing the processor to:
enable a camera to provide a real world scene if the electronic device is in a locked state;
display an unlocking interface on the display, the unlocking interface comprising the real world scene and one or more virtual objects superimposed on the real world scene;
detect an interaction with the unlocking interface; and
switch the electronic device to an unlocked state if the interaction satisfies a predefined rule.

12. The method according to claim 3, further comprising: changing dynamically the state of one or more of the virtual objects in response to the interaction with the unlocking interface.

13. The electronic device according to claim 8, the operation further comprising: changing dynamically the state of one or more of the virtual objects in response to the interaction with the unlocking interface.
